(19) United States
(12) Patent Application Publication
(10) Pub. No.: US 2026/0355555 A1
(43) Pub. Date: Nov. 12, 2026

(54) FLUID DISCHARGING DEVICE

(71) Applicant: AIRBUS DEFENCE AND SPACE, S.A.U., Madrid (ES)

(72) Inventor: Antonio ALCÓN SÁNCHEZ, GETAFE (ES)

(21) Appl. No.: 19/135,237

(22) PCT Filed: Dec. 18, 2023
(86) PCT No.: PCT/EP2023/086278

§ 371 Date: Jun. 3, 2025

(30) Foreign Application Priority Data
Dec. 19, 2022 (EP) 22383239.5

(51) Int. Cl. A62C 31/03; A62C 3/02; B64D 1/16

(52) U.S. Cl. CPC A62C 31/03; A62C 3/0242; B64D 1/16

(57) ABSTRACT

A device for discharging fluid off an aircraft. The device includes two articulation members, a foldable nozzle with an inlet, an outlet, a plurality of frames and a covering material located in between frames of the plurality of frames. The plurality of frames have two ends rotatably attached to the articulation members and are configured to be rotated. A portion of the inlet of the foldable nozzle configured to be closed and the nozzle further has a deflector plate located in between at least two frames of the plurality of frames. Also a firefighting system, an aircraft, and a method for discharging fluid off an aircraft.

### CROSS-REFERENCES TO RELATED APPLICATIONS

This application is a national phase of International Patent Application No. PCT/EP2023/86278, filed Dec. 18, 2023, which claims priority under 35 U.S.C. §§ 119 and 365 to European Application No. 22383239.5 filed Dec. 19, 2022, the entire disclosures of which are incorporated herein by way of reference.

### FIELD OF THE INVENTION

The present invention relates to devices for discharging fluid off an aircraft. More particularly, the present invention relates to discharging devices for firefighting aircraft. In addition, the present invention also relates to a firefighting system comprising said device, an aircraft comprising said firefighting system and a method for discharging fluid off an aircraft by means of said firefighting system.

### BACKGROUND OF THE INVENTION

In the aeronautical technical field, aerial firefighting makes use of specific aircrafts or helicopters as resources additional to the on-ground forces in order to combat wildfires.

In particular, firefighting aircraft bring support to the firefighters on the ground and can access steep, rocky, difficult to reach or unsafe areas before ground forces are able to make contact with these areas.

In particular, these aircraft, also called airtanker, have a fixed wing able to carry large volumes of fluid, normally fire retardant or water, in order to drop it on or in front of a fire and help slowing down the target fire. Fire retardants are known as a mix of chemicals or fluid such as salt compound, water, clay or thickening agent and colouring agent. These types of fire retardants are usually used to slow down or retard the spread of a target fire.

Fluid discharged off aircraft, particularly the first attack on the target fire, generally depend on the location of the fire, the fuels that are located in the area such as vegetation, timber, homes etc. and/or the current weather condition during intervention. Most fires are caught within the first two hours of a burning period which make the effectiveness and accuracy of the fluid discharging event off the aircraft crucial.

Existing firefighting systems/kits based on military transport aircraft are known in the art, these systems or kits are based on gravity conditions and pressurized water drop through the cargo ramp or lateral doors which do not use any redirector devices and, thus, are not capable of altering the geometry of the fluid stream discharged off the aircraft.

Firefighter kits or systems are known as temporary construction or devices that are placed inside the cabin of an aircraft, preferably in the cargo bay, cargo area or cargo body in, or around, the fuselage.

In fire extinguishing operations, the effectiveness of the fluid drop action is very important. However, firefighting aircraft nowadays provide poor control of the concentration of the discharged fluid and also of the pattern distribution reaching the target fire and corresponding terrain level.

Therefore, there is a need in the art for a device with an adaptive fluid discharging stream, having high effectiveness and avoiding excessive water stream distortion while discharging occurs.

### SUMMARY OF THE INVENTION

The present invention provides a device for discharging a fluid off an aircraft, a firefighting system, an aircraft, and a method for discharging a fluid off an aircraft.

In a first inventive aspect, the invention provides a device for discharging a fluid off an aircraft, the device comprising:
two articulation members,
a foldable nozzle having an inlet, an outlet, a plurality of frames and a covering material located in between frames of the plurality of frames, wherein the plurality of frames have two ends rotatably attached to the articulation members,
actuating means configured for rotating the plurality of frames, and
   closing means configured for closing a portion of the inlet of the foldable nozzle,
wherein
   the foldable nozzle further comprises a deflector plate located in between at least two frames of the plurality of frames.

The device of the invention comprises two articulation members, a foldable nozzle, actuating means and closing means. The foldable nozzle has a plurality of frames defining an inlet and an outlet. The plurality of frames have ends rotatably attached to the articulation members and operated by means of the actuating means. The articulation members, and thus the ends of the plurality of frames, are separated one from the other in order to define the shape of the inlet of the foldable nozzle.

In some embodiments, the foldable nozzle has a round wedge shape.

The closing means of the device of the invention are configured for closing a portion of the inlet of the foldable nozzle, thus reducing fluid backflow towards the aircraft. In some embodiments, the closing means cover an upper portion of the inlet of the foldable nozzle.

Discharging fluid while in flight provokes the formation of airflow vortex due to the in-flight conditions and to the pattern created by the fluid discharged. The device of the invention has an outlet which, in operation, is distant from the aircraft and the device is able to adapt the trajectory of the fluid so that the airflow vortex occurs at a farther distance from the aircraft, avoiding fluid stream distortion due to in-flight conditions.

The actuating means are configured for rotating the plurality of frames of the foldable nozzle. The position of the frames defines the position of the foldable nozzle, which can be a retracted position, a fully extended position or at least one intermediate extended position between the retracted position and the fully extended position. Each of these positions consequently orientates the outlet of the foldable nozzle in a different direction which provides its adaptive capacity to the device of the invention.

In some embodiments, the actuating means are operated mechanically or manually. In some embodiments, the actuating means are configured to deploy the foldable nozzle to one or more predetermined positions. In particular, the predetermined position influences the orientation of the outlet of the foldable nozzle, thus influences and modifies the trajectory of the fluid discharged. Preferably, there are a plurality of predetermined positions.

A covering material is located in between frames of the plurality of frames and said covering material is attached to the plurality of frames, preferably using attachment means. In some embodiments, the covering material is able to stretch so that the foldable nozzle can switch between a retracted position, where the plurality of frames are folded, and a fully extended position, where the plurality of frames and the covering material are both deployed completely. In some embodiments, the covering material is arranged such as to be extended when the foldable nozzle is in an extended position and to be folded when the foldable nozzle is in the retracted position.

The foldable nozzle of the device also comprises a deflector plate located in between at least two frames of the plurality of frames. In some embodiments, the deflector plate is located on the inner part of the foldable nozzle. In other embodiments, the deflector plate is located on the outer part of the foldable nozzle. In some other embodiments, the deflector plate is located on both the inner and the outer part of the foldable nozzle. The deflector plate, independently of its location, allows modifying and adapting the direction of the fluid discharged off the aircraft so that the trajectory of the fluid is improved and more efficient for extinguishing a target fire.

In the embodiment where the deflector plate is located on the inside part of the foldable nozzle, the deflector plate allows highest capacities of modifying and adapting the direction of the fluid discharged since the fluid enters directly in contact with the deflector plate.

The device of the invention provides a more effective fluid concentration discharged off the aircraft and the pattern distribution of the fluid is able to reach the target in an optimal manner.

The foldable nozzle of the present device provides an improved spreading pattern of the fluid discharged off the aircraft by modifying the trajectory of said fluid. In particular, the deflector plate helps adapting the fluid stream into a more vertical trajectory, thus diminishing the effect of the rear aircraft airflow and vortex created during in-flight conditions and avoiding excessive water stream distortion. This results in improved effectiveness.

Also, the device of the invention can be maintained permanently on an aircraft due to the possibility of having the foldable nozzle in a retracted position, since in retracted position the foldable nozzle has no impact on the in-flight conditions for the aircraft.

In some embodiments, the covering material is attached to the plurality of frames by means of glue, rivets or sewed. In some embodiments, the covering material comprises a plurality of enclosures configured for receiving the frames. The enclosures may be made of the same material as the covering material or of a different material. In some embodiments, at least one frame is attached to the covering material by only one enclosure. In some embodiments, at least one frame is attached to the covering material by a plurality of enclosures, each enclosure configured to receive a different portion of the frame. In some embodiments, the at least one enclosure is strapped to the corresponding frame by means of clips or retaining jaws arranged to grasp at the frame. In some embodiments, the clips or retaining jaws are fixed to the at least one enclosure by means of glue, rivets or sewed, or any other suitable means, depending on the material of the enclosure. In some embodiments, if the material allows it, like rubber or silicon, the at least one enclosure comprises at least one mechanical attachment embedded in the enclosure material, such as in form of lock hooks made of the same material or as inclusion of a dedicated joint element of the same or of a different material.

In a particular embodiment, the device further comprises supporting means arranged connecting the articulation members.

The supporting means provides additional rigidity and stability to the device of the invention. More particularly, the supporting means ensures that the shape of the inlet and the outlet are not altered while the fluid is discharged in-flight.

In some embodiments, the supporting means is a rod or a shaft. In these embodiments, the supporting means arranged connecting the articulation members may be considered as a rotation axis of the plurality of frames of the foldable nozzle.

In some other embodiments, the supporting means is a plate integral with both of the articulation members.

In a particular embodiment, the deflector plate is located between the last two successive frames of the plurality of frames at the outlet of the foldable nozzle.

Advantageously, by placing the deflector between the last two successive frames of the plurality of frames at the outlet of the foldable nozzle, the trajectory of the fluid discharged off the aircraft is adjusted in an optimal manner, since that is the portion of the foldable nozzle where more discharged fluid enters in contact due to the in-flight conditions.

When the deflector plate is located between the last two successive frames of the plurality of frames at the outlet of the foldable nozzle, the modifications of the trajectory of the fluid are optimal. That is, the changes of direction applied to the fluid are more precise and more effective.

In a particular embodiment, the actuating means comprise a manual actuator, an electro mechanic actuator, an electromotor actuator, a pneumatic actuator and/or an hydraulic actuator.

Advantageously, when the actuating means comprises an electro mechanic actuator, an electromotor actuator, a pneumatic actuator and/or an hydraulic actuator, the device is able to be controlled automatically and set in one of a plurality of predetermined positions.

In some embodiments, the device is able to switch in between these predetermined positions at any time while in flight.

In a particular embodiment, the actuating means further comprise locking means configured for locking the foldable nozzle.

Advantageously, the locking means help locking the foldable nozzle in a specific predetermined position during the entirety of the discharging operation, enhancing security.

In some embodiments, the locking means are security pins located at each of the articulation members.

In a particular embodiment, the deflector plate is made of metallic or composite material.

Advantageously, in this embodiment the deflector plate has high rigidity so that said deflector plate is able to endure high forces generated by the flow of the discharged fluid.

In a particular embodiment, the covering material is made of textile or plastic material.

In a particular embodiment, the outlet of the foldable nozzle, in an extended position, is located approximately in a range of [−20; +20] degrees with respect to horizontal datum.

Horizontal datum may be understood as a series of data points on the surface of the earth that are used to measure the position of a target with respect to the earth's surface. In particular, horizontal datum helps orienting and situating an object, a person or a target. In the particular case of the present invention, the horizontal datum help to configure the extended position of the device in which a specific predetermined position of the outlet of the foldable nozzle is required for a specific target when located at a specific location.

Advantageously, by adapting the angle of the foldable nozzle at which the fluid is discharged, the device of the invention is able to adapt to different fluid discharge angle configurations in order to provide optimal operational discharge conditions for a required fire target.

Also, the outlet of the foldable nozzle can be deployed at a predetermined angle before the operation and the foldable nozzle can be secured in that specific position by means of the locking means.

In some embodiments when the actuating means is mechanical, the predetermined positions can be activated from said actuating means and adjustable at any time while the aircraft is in flight.

In a particular embodiment, the plurality of frames are telescopic frames configured for extending away from the articulation members.

Advantageously, in this embodiment the telescopic frames allow adapting the area of the foldable nozzle in order to provide optimal condition of fluid discharge.

In some embodiments, the covering material has extending capacities to be able to adapt to the extension of the telescopic frames.

In some embodiments, the telescopic frames are attached to the covering material by means of an enclosure. When the telescopic frame is in an extended position, the enclosure is also extended to be able to adapt to the enlarged length of the telescopic frame. When the telescopic frame is in a non-extended position, the enclosure is folded, preferably in zig zag form.

In some embodiments, the telescopic frames comprise a plurality of portions having different shape and/or dimension and configured to fit one inside another. These portions create some interfaces at the junction where one portion fit inside the previous portion of a telescopic frame. In an embodiment of the frames portions fitting one inside of the other, a fluid seal is located at every interfaces in between portions of the telescopic frames in order to avoid the fluid discharged by the invention to escape through said interfaces in between telescopic frames.

In some embodiments, the covering material is attached to the telescopic frames by means of attachment means. In some embodiments the attachment means are strapped to the frame by means of clips or retaining jaws to grasp at the frame. In some embodiments the clips or retaining jaws are fixed to the covering material enclosing the telescopic frames by means of glue, rivets or sewed, depending on the material. If some embodiments, where the covering material allows it, such as rubber or silicon, the attachment means may be melted or embedded in the covering material.

In a second inventive aspect, the invention provides a firefighting system comprising a device for discharging a fluid off an aircraft according to any embodiment of the first inventive aspect of the invention.

In a particular embodiment of the second inventive aspect, the firefighting system further comprises a tank and a discharge conduct having an inlet and an outlet, wherein the tank is in fluid communication with the inlet of the discharge conduct and wherein the device is in fluid communication with the outlet of the discharge conduct.

The device of the present invention is able to adapt to any shape of the discharge conduct of the firefighting system.

Advantageously, the device of the invention is able to be mounted at the outlet of the discharge conduct. More particularly, any embodiment of the first inventive aspect is able to fit at the edge of the discharge conduct, that is, near the outlet of the discharge conduct. In an embodiment, in operation, with the firefighting system mounted in an aircraft, the device of the invention is mounted either in the cargo bay of the aircraft or in or around the fuselage of the aircraft.

In an embodiment, the ratio between the area of the outlet of the foldable nozzle and the area of the outlet of the discharge conduct is in the range from 0.9 to 1.3. Advantageously, when the ratio is in this particular range, the discharging fluid flow density is maintained during the stream deflection. In this embodiment, the ratio between the area of the outlet of the foldable nozzle and the area of the outlet of the discharge conduct is set such that undesired modification of the intended fluid stream or fluid flow is minimized. Said ratio provides more effective fluid distribution pattern when the discharged fluid reaches the ground.

In a third inventive aspect, the invention provides an aircraft comprising a firefighting system according to any embodiment of the second inventive aspect.

In a particular embodiment of the third inventive aspect, the aircraft further comprises controlling means configured for controlling the actuating means.

In some embodiments, the actuating means can be controlled from the cockpit and/or from the cargo bay area of the aircraft so that the device of the invention can be adapted to the conditions required for discharging the fluid at a specific target.

In a fourth inventive aspect, the present invention provides a method for discharging a fluid off an aircraft, the method comprising the following steps:
a) providing a firefighting system according to any embodiment of the second inventive aspect or an aircraft according to any embodiment of the third inventive aspect,
b) extending the foldable nozzle by means of the actuating means until the outlet of the foldable nozzle reaches a predetermined position,
c) discharging the fluid off the aircraft.

In some embodiments, in step b) of the method of the fourth inventive aspect of the invention, the actuating means comprise a manual actuator, an electro mechanic actuator, an electromotor actuator, a pneumatic actuator and/or an hydraulic actuator.

In some embodiments, the actuating means comprise locking means configured for locking the foldable nozzle in order to block the foldable nozzle in a specific position.

During step c), when the fluid is discharged off the aircraft via the discharge conduct and through the device of any embodiment of the first inventive aspect, the fluid enters in contact with the part of the foldable nozzle where the deflector plate is arranged, which influences the trajectory and direction of the fluid.

At the same time, also during step c), the closing means of the device of the present invention prevents that any fluid backflow towards the aircraft occurs while discharging said fluid off the aircraft. Therefore, optimal quantity of fluid is discharged to the target and security of the aircraft is enhanced.

In a particular embodiment of the fourth inventive aspect, the predetermined position of step b) is selected from a first, a second or a third predetermined position and wherein:
at the first predetermined position, the outlet of the foldable nozzle is oriented at −20 degrees with respect to horizontal datum,
at the second predetermined position, the outlet of the foldable nozzle is parallel to horizontal datum,
at the third predetermined position, the outlet of the foldable nozzle is oriented at +20 degrees with respect to horizontal datum.

Each of the predetermined positions above mentioned allows adapting the foldable nozzle, more particularly the orientation of the outlet of the foldable nozzle, to a specific fluid discharging angle which is optimal for the conditions of the firefighting operation, that is with respect to the target and its coordinate calculated based on the horizontal datum.

All the features described in this specification (including the claims, description and drawings) and/or all the steps of the described method can be combined in any combination, with the exception of combinations of such mutually exclusive features and/or steps.

### BRIEF DESCRIPTION OF THE DRAWINGS

These and other characteristics and advantages of the invention will become clearly understood in view of the detailed description of the invention which becomes apparent from a preferred embodiment of the invention, given just as an example and not being limited thereto, with reference to the drawings.

FIG. 1 shows a perspective view of a firefighting system according to an embodiment of the invention.

FIG. 2 shows a side view of a firefighting system according to an embodiment of the invention.

FIG. 3 shows a side view of a device for discharging fluid off an aircraft according to an embodiment of the invention in a retracted position.

FIG. 4 shows a schematic side view of a firefighting system according to an embodiment of the invention.

FIG. 5 shows a schematic view of an aircraft according to an embodiment of the invention.

### DETAILED DESCRIPTION OF THE PREFERRED EMBODIMENTS

FIG. 1 shows a perspective view of an embodiment of a firefighting system (10) for discharging fluid off an aircraft according to the invention. In this figure some elements are depicted as partially transparent to be able to observe other elements which otherwise would not be visible.

In this embodiment, a device (1) for discharging a fluid off an aircraft is mounted at the outlet (11.1) of a discharge conduct (11). The device (1) has two articulation members (2.1, 2.2) located on each side of the discharge conduct (11). In this specific embodiment, the two articulation members (2.1, 2.2) are mounted on the exterior sides of the discharge conduct (11).

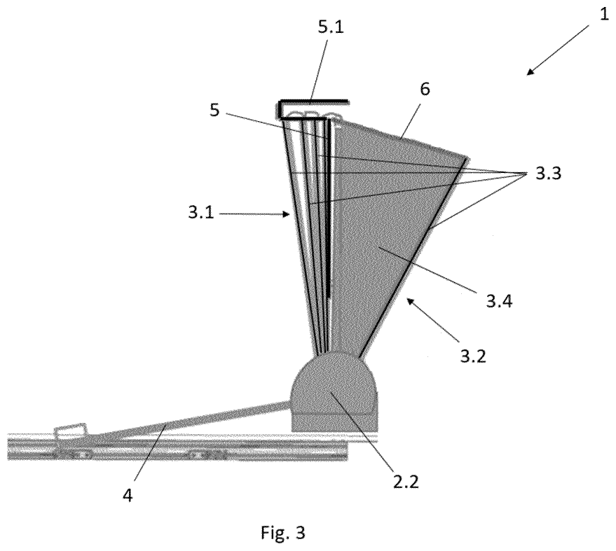

The device (1) also comprises a foldable nozzle (3) which, in FIG. 1, is shown in a fully extended position. In order for the foldable nozzle (3) to be extended or retracted, the device (1) comprises actuating means (4). In FIG. 1, the actuating means (4) are manual and can be switched from a first position, substantially parallel to the discharge conduct (11) (not shown in FIG. 1), when the device (1) is in a retracted position (as shown in FIG. 3 and described further in the present document), to a second position substantially perpendicular to the discharge conduct (11).

In some other embodiments, the actuating means (4) comprise an electro mechanic actuator, an electromotor actuator, a pneumatic actuator and/or an hydraulic actuator.

In some embodiments, not shown in this Figure, the actuating means (4) further comprise locking means configured for locking the foldable nozzle.

The foldable nozzle (3) of the embodiment shown in FIG. 1 comprises an inlet (3.1) which is in fluid communication with the outlet (11.1) of the discharge conduct (11). A portion of the inlet (3.1) of the foldable nozzle (3) is partly covered by closing means (5) which avoid any fluid backflow towards the aircraft when the firefighting system (10) is arranged in an aircraft and the fluid is discharged off the firefighting system (10).

The foldable nozzle (3) also comprises a plurality of frames (3.3) having two ends (3.3.1). Each end (3.3.1) is rotatably attached to one of the two articulation members (2.1, 2.2). Due to the orientation of the view of FIG. 1, only one end (3.3.1) is visible, the other end being hidden by an articulation member (2.2).

In this specific embodiment shown in FIG. 1, supporting means (7) are arranged connecting the articulation members (2.1, 2.2) in order to provide additional support and stability while defining the shape of the inlet (3.1) of the foldable nozzle (3). In particular, in this embodiment the supporting means (7) is a rod or shaft extending from one articulation member (2.1, 2.2) to the other.

In this particular embodiment the foldable nozzle (3) comprises six frames (3.3), and a covering material (3.4) is located in between frames of the plurality of frames (3.3). In some embodiments, the covering material (3.4) is made of textile or plastic material.

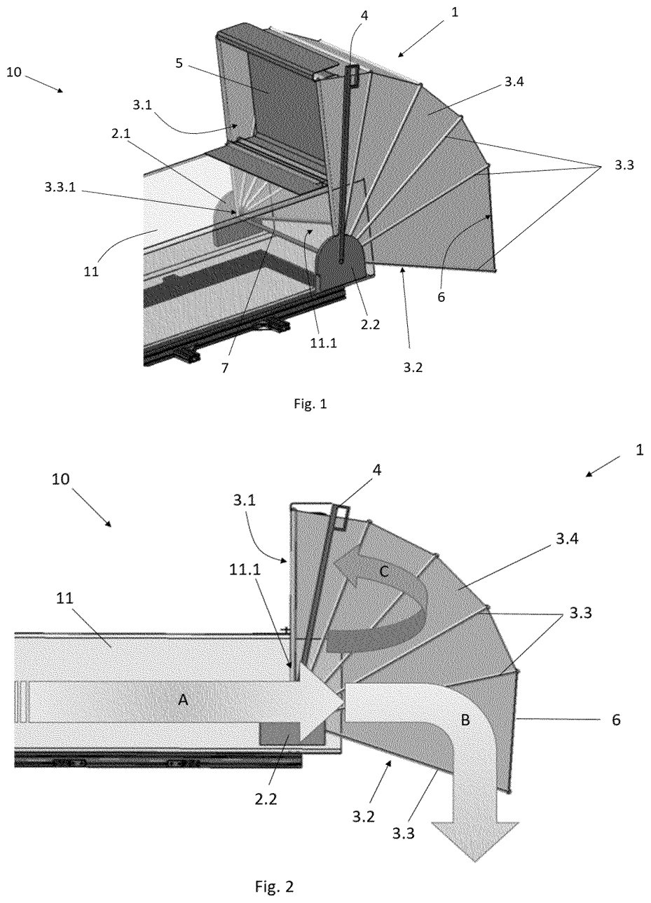

The foldable nozzle (3) of the device (1) of the invention also comprises a deflector plate (6) located in between at least two frames of the plurality of frames (3.3). In particular, in FIG. 1, the deflector plate (6) is located between the last two successive frames of the plurality of frames (3.3) at the outlet (3.1) of the foldable nozzle (3). In operation, the deflector plate (6) is arranged facing the fluid flow discharged via the discharge conduct (11) so that said fluid enters in contact with the deflector plate (6) and the trajectory of the fluid is modified. Flow directions and changes of trajectories are schematically represented in FIGS. 2 and 3.

In some embodiments, the deflector plate (6) is made of metallic or composite material.

In some embodiments, the plurality of frames (3.3) are telescopic frames configured for extending away from the articulation members (2.1, 2.2).

Also, the firefighting system (10) further comprises a tank, not shown in the embodiment of the firefighting system (10) of FIG. 1, wherein the tank is in fluid communication with the inlet (also not shown) of the discharge conduct (11) and wherein the device (1) is in fluid communication with the outlet (11.1) of the discharge conduct (11).

FIG. 2 shows a side view of the embodiment already depicted in FIG. 1 where the firefighting system (10) comprises a device (1) according to an embodiment of the invention and said device (1) is represented in an extended position. Also, FIG. 2 schematically shows the flow pattern of a fluid discharging operation.

As shown in FIG. 2, the fluid is discharged off an aircraft from a tank (not shown) towards the outlet (11.1) of the discharge conduct (11) as represented by arrow A. Once the fluid reaches the inlet (3.1) of the foldable nozzle (3), the fluid gets into the foldable nozzle (3) and enters in contact with the deflector plate (6), located between the last two successive frames of the plurality of frames (3.3) at the outlet (3.1) of the foldable nozzle (3) in this embodiment. By contacting the deflector plate (6), the fluid trajectory is modified so that said fluid is discharged towards the target through the outlet (3.2) of the foldable nozzle (3) following the path of arrow B.

When discharging a fluid off an aircraft, fluid backflow occurs as represented by arrow C which provokes water ingestion inside the aircraft. In that sense, the device (1) of the invention provides closing means (5), partially visible in this side view of the firefighting system (10), so that a portion of the inlet (3.1) of the foldable nozzle (3) is covered by said closing means (5), which avoid fluid backflow.

FIG. 3 shows a side view of an embodiment of the device (1) of the invention where the foldable nozzle (3) is in a retracted position. In this retracted position, the plurality of frames (3.3) are shown in such a position that the covering material (3.4) is not extended. In this embodiment, the covering material is folded, similarly to a bellows, in the retracted position of the foldable nozzle. However, the two successive frames of the plurality of frames (3.3) where the deflector plate (6) is located are always extended due to the rigidity provided by the deflector plate (6) to this particular area of the foldable nozzle (3). In this particular embodiment, the deflector plate (6) is located between the last two successive frames of the plurality of frames (3.3) at the outlet (3.2) of the foldable nozzle (3).

In this embodiment, the closing means (5) are embodied as a folded plate which defines a receiving portion (5.1) configured for receiving some of the frames (3.3).

In that same embodiment of FIG. 3, the actuating means (4), represented in this figure as a manual actuator, are shown in a low position which corresponds to the retracted position of the foldable nozzle (3). Also, when in a retracted position, the plurality of frames (3.3), except the last two successive frames of the plurality of frames (3.3), are retracted and placed inside the receiving portion (5.1) of the closing means (5).

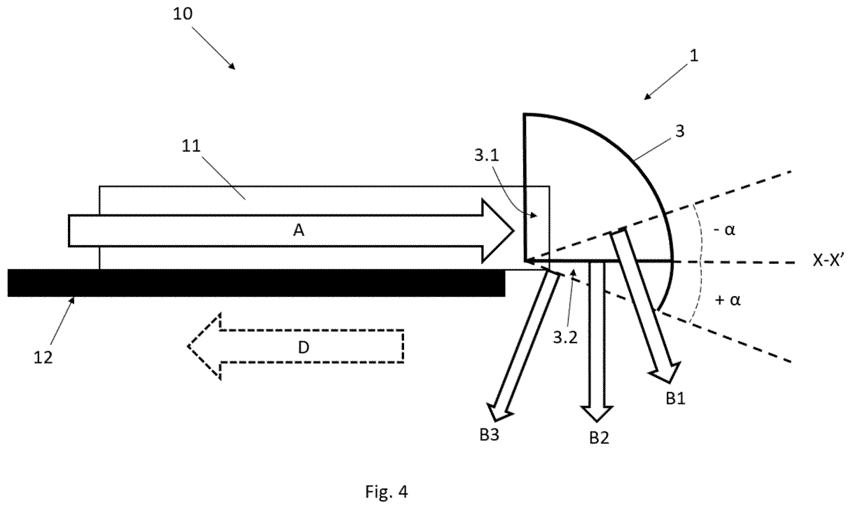

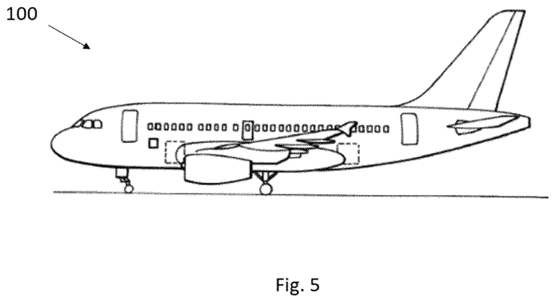

FIG. 4 depicts a schematic view of an embodiment of the firefighting system (10), with the foldable nozzle (3) in an extended position. In particular, FIG. 4 shows several predetermined positions that can be selected for the outlet (3.2) of the foldable nozzle (3) following the condition of fluid discharge required for a specific target.

The fluid flow inside the discharge conduct (11) is represented by arrow A compared to the flight direction represented by arrow D. The discharge conduct (11) is placed over a portion of a cargo area (12) of an aircraft.

As shown in FIG. 4, the foldable nozzle (3) is extended by means of the actuating means until the outlet (3.2) of the foldable nozzle (3) reaches a predetermined position. In particular embodiments, the predetermined position is selected between a first, a second or a third position.

In some embodiments, the outlet (3.2) of the foldable nozzle (3), in an extended position, is located approximately in a range of [−α; +α] degrees with respect to horizontal datum. In an embodiment a is substantially 20 degrees.

As depicted in FIG. 4, the second predetermined position is a position where the outlet (3.2) of the foldable nozzle (3) is parallel with respect to horizontal datum as defined previously in the present document. In that case, the outlet (3.2) is located along an axis X-X′ and said orientation of the outlet (3.2) helps modifying the trajectory of the fluid entering the device (1) so that the fluid is discharged in a direction following arrow B2, substantially perpendicular to the flight direction represented by arrow D.

Also in the embodiment depicted in FIG. 4, a first predetermined position can be selected so that the outlet (3.2) of the foldable nozzle (3) is oriented at −α degrees with respect to the horizontal datum. In that specific predetermined position, the trajectory of the fluid is modified such as the direction of the fluid follows the direction as represented by arrow B1.

Finally, in the embodiment shown in FIG. 4, the third predetermined position can be selected so that the outlet (3.2) of the foldable nozzle (3) is oriented at +α degrees with respect to the horizontal datum. In that specific predetermined position, the trajectory of the fluid is modified such as the direction of the fluid follows the direction represented by arrow B3.

In some embodiments, where the actuation means are mechanical and controllable via control means, the predetermined position can be selected between the first, the second or the third predetermined position and changed at any time while in-flight so that the outlet (3.2) of the foldable nozzle (3) is always oriented in an optimal way with respect to the horizontal datum so that the fluid can be efficiently discharged on a target.

FIG. 5 depicts an aircraft (100) comprising a firefighting system (10) according to an embodiment of the invention.

In some embodiments, the firefighting system (10) further comprises a tank and a discharge conduct having an inlet and an outlet, wherein the tank is in fluid communication with the inlet of the discharge conduct and wherein the device is in fluid communication with the outlet of the discharge conduct.

In some further embodiments, the aircraft (100) further comprises controlling means (not shown) configured for controlling the actuating means (4). Preferably, the controlling means are located inside the fuselage of the aircraft (100).

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1.-15. (canceled)

16. A device for discharging a fluid off an aircraft, the device comprising:
two articulation members;
a foldable nozzle having an inlet, an outlet, a plurality of frames and a covering material located in between frames of the plurality of frames, wherein the plurality of frames has two ends rotatably attached to the articulation members;
actuating means configured for rotating the plurality of frames; and
closing means configured for closing a portion of the inlet of the foldable nozzle,
wherein the foldable nozzle further comprises a deflector plate located in between at least two frames of the plurality of frames.

17. The device according to claim 16, further comprising:
supporting means arranged connecting the articulation members.

18. The device according to claim 16, wherein the deflector plate is located between a last two successive frames of the plurality of frames at the outlet of the foldable nozzle.

19. The device according to claim 16, wherein the actuating means comprise a manual actuator, an electro mechanic actuator, an electromotor actuator, a pneumatic actuator, a hydraulic actuator, or any combination thereof.

20. The device according to claim 16, wherein the actuating means further comprise locking means configured for locking the foldable nozzle.

21. The device according to claim 16, wherein the deflector plate is made of a metallic material or a composite material.

22. The device according to claim 16, wherein the covering material is made of a textile or a plastic.

23. The device according to claim 16, wherein the outlet of the foldable nozzle, in an extended position of the foldable nozzle, is located in a range of −20 or +20 degrees with respect to horizontal datum.

24. The device according to claim 16, wherein the plurality of frames are telescopic frames configured for extending away from the articulation members.

25. A firefighting system comprising:
the device for discharging a fluid off an aircraft according to claim 16.

26. The firefighting system according to claim 25, further comprising:
a tank; and
a discharge conduct having an inlet and an outlet,
wherein the tank is in fluid communication with the inlet of the discharge conduct and wherein the device is in fluid communication with the outlet of the discharge conduct.

27. An aircraft comprising:
the firefighting system according to claim 25.

28. The aircraft according to claim 27, further comprising:
controlling means configured for controlling the actuating means.

29. A method for discharging a fluid off an aircraft, the method comprising the following steps:
a) providing the firefighting system according to claim 25;
b) extending the foldable nozzle by the actuating means until the outlet of the foldable nozzle reaches a predetermined position; and,
c) discharging the fluid off the aircraft.

30. The method according to claim 29, wherein the predetermined position of step b) is selected from a first predetermined position, a second predetermined position, or a third predetermined position,
wherein as the first predetermined position, the outlet of the foldable nozzle is oriented at −20 degrees with respect to horizontal datum,
wherein at the second predetermined position, the outlet of the foldable nozzle is parallel to horizontal datum, and,
wherein at the third predetermined position, the outlet of the foldable nozzle is oriented at +20 degrees with respect to horizontal datum.
